(19) United States
(12) Patent Application Publication
(10) Pub. No.: US 2009/0267494 A1
(43) Pub. Date: Oct. 29, 2009

(54) ORGANIC LIGHT EMITTING DIODE DISPLAY AND MANUFACTURING METHOD THEREOF

(75) Inventors: Hae-Yeon Lee, Bucheon-si (KR); Baek-Woon Lee, Yongin-si (KR); Young-In Hwang, Yongin-si (KR); Young-Gu Ju, Daegu-si (KR)

Correspondence Address: H.C. PARK & ASSOCIATES, PLC, 8500 LEESBURG PIKE, SUITE 7500, VIENNA, VA, 22182, US

(73) Assignees: Samsung Electronics Co., Ltd., Suwon-si (KR); Kyungpook National University Industry-Academic Cooperation Foundation, Daegu-si (KR)

(21) Appl. No.: 12/328,265

(22) Filed: Dec. 4, 2008

(30) Foreign Application Priority Data
Apr. 23, 2008 (KR) 10-2008-0037779

(51) Int. Cl. H01J 1/62; H01J 9/20

(52) U.S. Cl. 313/504; 445/24

(57) ABSTRACT

An OLED display and a manufacturing method of the OLED display are disclosed. The OLED display includes a first pixel, a second pixel, a third pixel, a substrate, an overcoating film formed on the substrate, and a translucent member formed on the overcoating film. The translucent member includes a multi-layered structure that includes a metal layer as the lowest layer, a first electrode is formed on the translucent member, an emission member is formed on the first electrode, and a second electrode is formed on the emission member.

### CROSS-REFERENCE TO RELATED APPLICATION

This application claims priority from and the benefit of Korean Patent Application No. 10-2008-0037779, filed on Apr. 23, 2008, which is hereby incorporated for all purposes as if fully set forth herein.

### BACKGROUND OF THE INVENTION

1. Field of the Invention

The present invention relates to an organic light emitting device and a manufacturing method thereof.

2. Discussion of the Background

As demand for lighter and thinner monitors and televisions has increased, organic light emitting diode (OLED) displays have received much attention as a display device that can satisfy this demand.

The OLED display includes two electrodes and an emission layer positioned between the two electrodes. Electrons injected from one electrode and holes injected from the other electrode combine in the emission layer to form exitons, and as the exitons discharge energy, the OLED display emits light.

The OLED display is a self-emission type of display that does not require a light source, and accordingly is advantageous in terms of power consumption and has a good response speed, viewing angle, and contrast ratio.

The OLED display includes organic light emitting members, each representing one of three primary colors such as red, green, and blue. The light emitting members representing different colors have different luminous efficiency since different materials are used as the organic light emitting members according to the colors. Currently, commercially available materials used as the light emitting members representing specifically one of the three primary colors have such low luminous efficiency that the light emitted from the organic material may not show a desired color coordinate, and a white light obtained by mixing the light of the specific color with lights of two other primary colors may not show a desired color coordinate.

As a method of supplementing this, a microcavity resonance has been used.

When a light is repeatedly reflected from a reflective layer and a translucent layer that are spaced apart by a predetermined distance (hereinafter referred to as an “optical path length”), the light experiences strong interferences such that a light having a particular wavelength experiences constructive interference to enhance its strength, while lights having other wavelengths experience destructive interference and vanish. The microcavity resonance uses this principle to improve the luminance and color reproducibility in a front view display device.

However, since an appropriate optical path length is different for different colors, the microcavity structure may be different for the pixels representing different colors. The manufacturing process, therefore, may require increased process steps.

### SUMMARY OF THE INVENTION

This invention provides an organic light emitting diode (OLED) display device and method of manufacturing the same in which the display may have increased color purity and reproducibility.

Additional features of the invention will be set forth in the description which follows, and in part will be apparent from the description, or may be learned by practice of the invention.

An embodiment of the present invention discloses an OLED display including a substrate, an overcoating film formed on the substrate, and a translucent member formed on the overcoating film. The translucent member includes a multi-layered structure that includes a metal layer as the lowest layer. A first electrode is formed on the translucent member, an emission member is formed on the first electrode, and a second electrode is formed on the emission member.

An embodiment of the present invention also discloses a method of manufacturing an OLED display. The method includes forming a thin film transistor (TFT) on a substrate, forming an overcoating film on the substrate and the TFT, forming a first transparent conductive layer on the overcoating film, forming an inorganic layer on the first transparent conductive layer, forming a second transparent conductive layer on the inorganic layer, etching the second transparent conductive layer and the first transparent conductive layer to form a first electrode and a metal layer, forming an emission member on the first electrode, and forming a second electrode on the emission member.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a circuit diagram of an OLED display according to an exemplary embodiment of the present invention.

FIG. 2 is a schematic top plan view of the alignment of a plurality of pixels in the OLED display according to an exemplary embodiment of the invention.

FIG. 3 is a cross-sectional view of an OLED display according to an exemplary embodiment of the invention.

FIG. 4, FIG. 5, FIG. 6, FIG. 7, FIG. 8, FIG. 9, FIG. 10, FIG. 11, FIG. 12, and FIG. 13 are cross-sectional views showing a method of manufacturing the OLED according to an exemplary embodiment of the invention.

FIG. 14 is a schematic diagram showing the layers in a translucent member according to an exemplary embodiment of the invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element such as a layer, film, region, or substrate is referred to as being “on” another element, it can be directly on the other element or intervening elements may also be present. In contrast, when an element is referred to as being “directly on” another element, there are no intervening elements present.

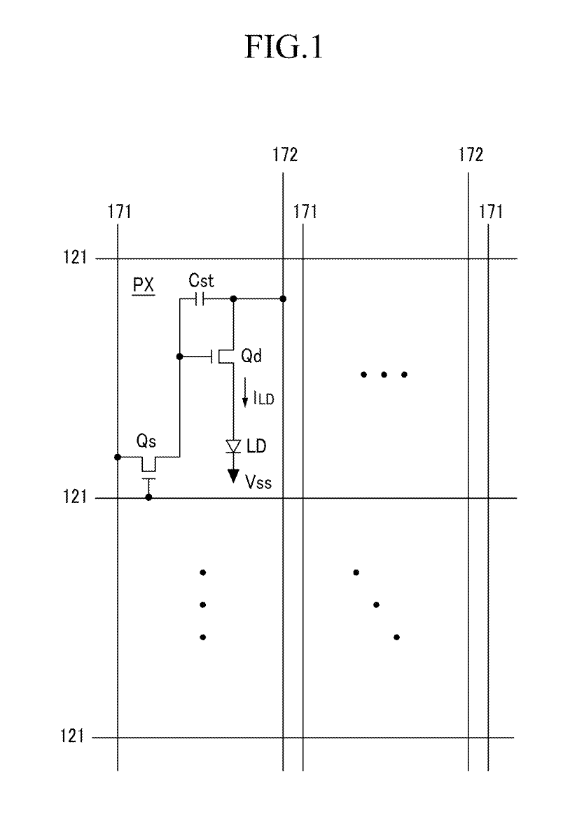

An organic light emitting diode (OLED) display according to an exemplary embodiment of the present invention will be described in further detail with reference to FIG. 1.

FIG. 1 is an equivalent circuit diagram of a pixel on an OLED display according to an exemplary embodiment of the present invention.

Referring to FIG. 1, the OLED display includes signal lines 121, 171, and 172, and a plurality of pixels PX respectively connected to the plurality of signal lines and arranged in a matrix.

The signal lines include gate lines 121 that transmit gate signals (or scanning signals), data lines 171 that transmit data signals, and driving voltage lines 172 that transmit a driving voltage. The gate lines 121 are substantially parallel with each other and extend substantially in a row direction, and the data lines 171 and the driving voltage lines 172 are substantially parallel with each other and extend substantially in a column direction.

Each pixel PX includes a switching thin film transistor (TFT) Qs, a driving TFT Qd, a storage capacitor Cst, and an organic light emitting diode (OLED) LD.

The switching TFT Qs includes a control terminal, an input terminal, and an output terminal. The control terminal of the switching TFT Qs is connected to one of the gate lines 121, its input terminal is connected to one of the data lines 171, and its output terminal is connected to the driving TFT Qd. The switching TFT Qs transmits data signals from the data line 171 to the driving TFT Qd in response to a scanning signal from the gate line 121.

The driving TFT Qd includes a control terminal, an input terminal, and an output terminal. The control terminal of the driving TFT Qd is connected to the switching TFT Qs, its input terminal is connected to one of the driving voltage lines 172, and its output terminal is connected to the OLED LD. The driving TFT Qd outputs an output current I_{LD} having a magnitude that varies according to a voltage applied between its control terminal and input terminal.

The storage capacitor Cst is connected between the control terminal and the input terminal of the driving TFT Qd. The storage capacitor Cst stores data signals applied to the control terminal of the driving TFT Qd and maintains the data signals after the switching TFT Qs turns off.

The OLED LD includes an anode connected to the output terminal of the driving TFT Qd and a cathode connected to a common voltage Vss. The OLED LD emits light having an intensity that varies in accordance with the output current I_{LD} of the driving TFT Qd, to display an image.

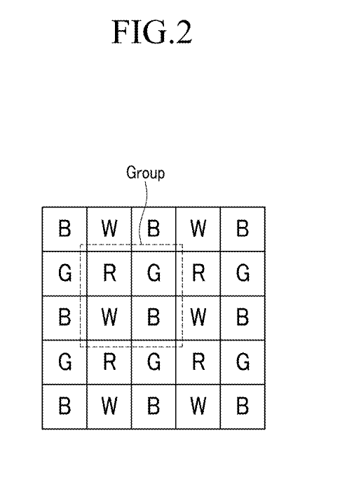

FIG. 2 is a schematic view of an arrangement of pixels in an OLED display according to an exemplary embodiment of the present invention.

Referring to FIG. 2, pixels including a red pixel R for representing a red color, a green pixel G for representing a green color, a blue pixel B for representing a blue color, and a white pixel W for representing white color are arranged in a 2×2 pixel group. Such a 2×2 pixel group can be repeatedly arranged along rows and/or columns. And the arrangement of the pixel group can be variously modified.

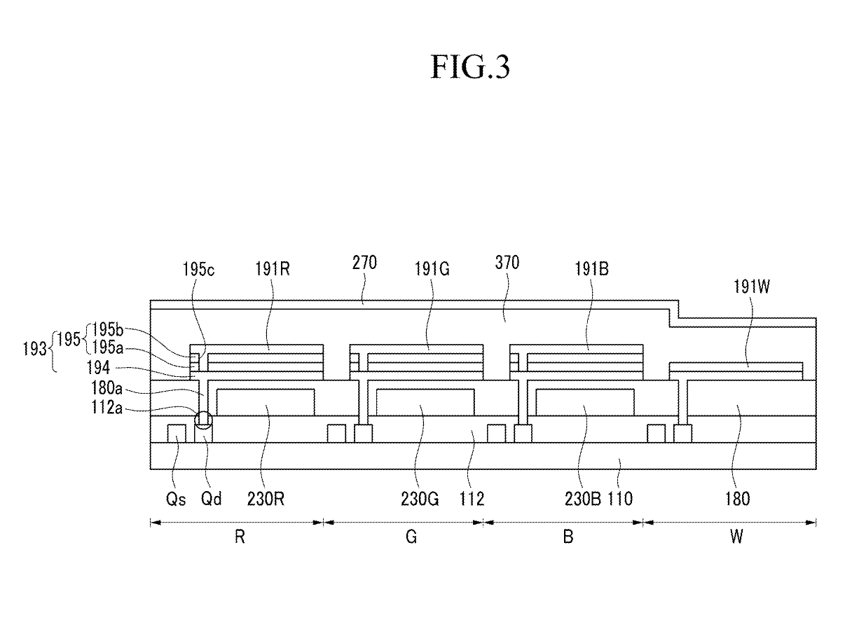

FIG. 3 is a cross-sectional view of an OLED display according to an exemplary embodiment of the present invention.

A plurality of thin film structures are formed on an insulation substrate 110. Each thin film structure is provided in a R, G, B, and W pixel and includes a switching TFT Qs and a driving TFT Qd that are electrically connected to each other.

An insulating layer 112 is formed on the thin film structures. The insulating layer 112 has contact holes 112a that partially expose the driving TFTs Qd.

Color filters 230R, 230G, and 230B are formed on the insulating layer 112. A red filter 230R is disposed in a red pixel R, a green filter 230G is disposed in a green pixel G, and a blue filter 230B is disposed in a blue pixel B. A white pixel W may include no color filter or a transparent white filter (not shown).

An overcoating film 180 is formed on the color filters 230R, 230G, and 230B and the insulating layer 112. The overcoating film 180 has contact holes 180a extending to the contact holes 112a of the insulating layer 112.

The overcoating film 180 may be made of a photosensitive organic material such as an acryl-based compound, and it may have a planarized surface to eliminate a step due to the color filters 230R, 230G, and 230B.

The top surface of the overcoating film 180 in the green pixel G may be uneven. The unevenness may scatter light to prevent a color shift depending on the viewing direction while changing the microcavity resonance condition in the green pixel G. This will be described in detail below.

Translucent members 193 are formed on the overcoating film 180.

The translucent member 193 in the green pixel G may have an unevenness induced by the unevenness of the top surface of the overcoating film 180. Each of the translucent members 193 in the red pixel R, the blue pixel B, and the green pixel G includes a metal layer 194 and an inorganic layer 195. The inorganic layer 195 includes a first layer 195a and a second layer 195b deposited on the first layer 195a. The inorganic layer 195 has a contact hole 195c. However, the translucent member 193 in the white pixel W includes only the metal layer 194.

The metal layer 194 of the translucent member 193 is electrically connected to the driving TFT Qd through the contact holes 180a and 112a.

The translucent member 193 partially transmits light and partially reflects light. The translucent member 193 is provided for using distributed Bragg reflection (DBR) for adjusting reflexibility for a specific wavelength. The translucent member 193 using the DBR will be described in detail below.

Pixel electrodes 191R, 191G, 191B, and 191W are formed on the translucent members 193. If the overcoating film 180 has an uneven surface, the pixel electrode 191G in the green pixel G may have unevenness induced by the uneven surface of the overcoating film 180.

Each of the pixel electrodes 191R, 191G, and 191B in the red pixel R, the blue pixel B, and the green pixel G, respectively, are connected to the metal layer 194 of the translucent member 193 through the contact hole 195c of the inorganic layer 195 of the translucent member 193, and the pixel electrode 191W in the white pixel W may directly contact the metal layer 194 of the translucent member 193. The pixel electrodes 191R, 191G, 191B, and 191W may be made of a transparent conductor such as ITO or IZO.

An organic emission layer 370 is formed on the pixel electrodes 191R, 191G, 191B, and 191W. The organic emission layer 370 may cover the entire surface of the insulation substrate 110.

Although not shown, an additional layer (not shown) may be included on and/or under the organic emission layer 370 to improve luminous efficiency. The additional layer may include at least one of an electron transport layer, a hole transport layer, an electron injection layer, or a hole injection layer.

Continuing, the organic emission layer 370 may be made of a material emitting white light or have a stacked structure including a plurality of sub-emission layers (not shown). Each of the sub-emission layers may be made of a material that emits a light of one of a red color, a green color, a blue color, etc. In the latter case, the lights emitted by the sub-emission layers are mixed to become a white light. The sub-emission layers may be arranged horizontally or stacked vertically, and the lights emitted by the sub-emission layers are not limited to a combination of red, green, and blue and may include any combination of colors that may be mixed to become a white light.

A portion of the organic emission layer 370 in the green pixel G may have unevenness induced by the unevenness of the top surface of the overcoating film 180.

A common electrode 270 is formed on the organic emission layer 370. The common electrode 270 may be made of a material having high reflectance. The common electrode 270 is paired with each of the pixel electrodes 191R, 191G, 191B, and 191W to allow current to flow through the organic light emitting member 370. A portion of the common electrode 270 in the green pixel G may have unevenness induced by the unevenness of the top surface of the overcoating film 180.

Each of the pixel electrodes 191R, 191G, 191B, and 191W, the organic emission layer 370, and the common electrode 270 form an OLED LD. The pixel electrodes 191R, 191G, 191B, and 191W may be anodes, and the common electrode 270 may be a cathode. Alternatively, the pixel electrodes 191R, 191G, 191B, and 191W may be cathodes and the common electrode 270 may be an anode.

The common electrode 270 generates a microcavity effect together with the translucent member 193. The microcavity resonance effect is to amplify light of a specific wavelength by constructive interference as light is repeatedly reflected from a reflective layer and a translucent layer that are spaced apart by an optical length. The common electrode 270 functions as a reflective layer, and the translucent member 193 functions as a translucent layer.

Due to the microcavity resonance effect, the common electrode 270 greatly improves the light emitting characteristics of light emitted from the organic emission layer 370, and light having a wavelength around a resonance wavelength for a microcavity among the improved light is strengthened through the translucent member 193 and light having other wavelengths is suppressed. The enhancement and suppression of light of a specific wavelength can be determined by the optical length, and the optical length can be adjusted by changing the thickness of the translucent member 193.

As described above, the translucent member 193 may generate the DBR, and it has a structure of stacked layers that may be made of metals and insulators having different refractive indices.

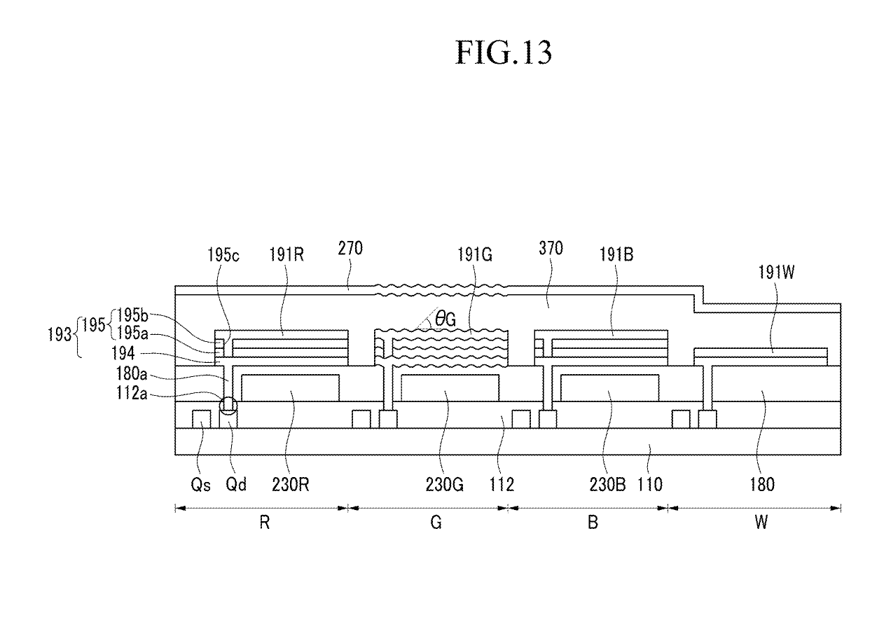

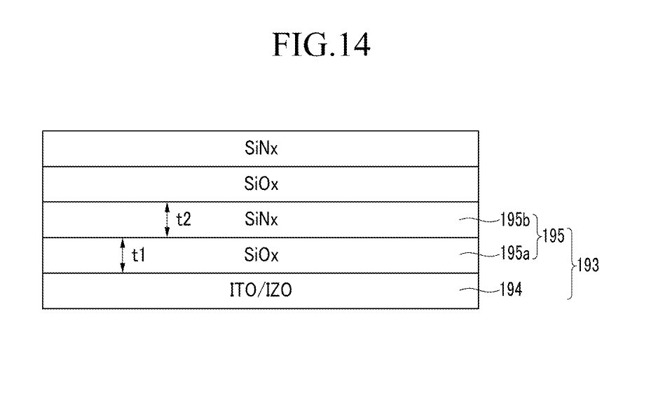

The translucent member 193 will now be described with reference to FIG. 14.

FIG. 14 is a schematic diagram illustrating a translucent member according to an exemplary embodiment of the present invention.

Referring to FIG. 14, the translucent member 193 has a structure where a metal layer 194 and an inorganic layer 195 are stacked. The inorganic layer 195 includes a first layer 195a and a second layer 195b that are repeatedly stacked, and the number of repetition is one or more. The metal layer 194 may be made of a metal having a refractive index of approximately 2.0, such as IZO or ITO. The first layer 195a and the second layer 195b may be made of inorganic materials having different refractive indices, for example the first layer 195a may be made of silicon oxide SiOₓ having a refractive index of about 1.4 and the second layer 195b may be made of silicon nitride SiNₓ having a refractive index of about 1.6.

When it is assumed that N number of first layers 195a and second layers 195b are stacked, the thickness of each of the first and second layers 195a and 195b can be determined by a function for a specific wavelength. For example, a thickness t1 of the first layer 195a and a thickness t2 of the second layer 195b can be determined in equation 1 and equation 2 as follows:

thickness t1=λ/4n₁ 1

thickness t2=λ/4n₂ 2

where n₁ is a refractive index of the first layer 195a, n₂ is a refractive index of the second layer 195b, and X is a wavelength of green light.

When a wavelength of a green region is about 530 nm, the first layer 195a is made of silicon oxide and the second layer 195b is made of silicon nitride, then thicknesses t1 and t2 of the first layer 195a and the second layer 195b may be about 945 Å and about 830 Å, respectively.

In order to represent a microcavity effect in each of the red pixel R, the green pixel G, and the blue pixel B, each pixel should have a different optical length, and the optical length can be adjusted by changing the thickness of the N inorganic layers 195 and the metal layer 194.

The thickness of the metal layer 194 can be formed such that the optical length satisfies a reinforcement interference condition in both the red pixel R and the blue pixel B. In this case, a process that is normally required for differently forming the optical length in each pixel can be eliminated.

An optical length L that satisfies the reinforcement interference condition in both the red pixel R and the blue pixel B is shown in equation 3:

L=mλ₁/2=m+1λ₂/2 3

where m is a natural number, λ₁ is a wavelength of red light, and λ₂ is a wavelength of blue light. According to an exemplary embodiment of the present invention, the optical length L can be determined to be the smallest value among values satisfying the reinforcement interference condition; for example, m=2.

The optical length that satisfies the reinforcement interference condition in both the red pixel R and the blue pixel B may be set, and the optical length of the green pixel G may be adjusted to unevenness that is formed in a surface of the overcoating film 180.

Since unevenness is formed in a surface of the overcoating film 180 of the green pixel G, the translucent member 193, the pixel electrode 191G, the organic emission layer 370, and the common electrode 270 that are stacked on the overcoating film 180 also have unevenness. Therefore, light that is emitted from the organic emission layer 370 is discharged to the outside after sequentially passing through the pixel electrode 191G, the overcoating film 180, the green filter 230G, and the substrate 110, and the light forms a predetermined tilt angle θ_{G} of unevenness from light that is vertically emitted to the substrate 110. The tilt angle θ_{G} of unevenness increases the green light by changing its path to one different from those of pixels R and B.

The path difference can be determined by either equations 4 or 5:

path difference=2nd′ cos θ_{G} 4

and path difference=λ/2 5

where n is a refractive index of an organic emission layer, d′ is an actual optical length, θ_{G} is the tilt angle of unevenness, and λ is a wavelength of green light.

When rearranging the path difference (4 and 5) equations, a wavelength that is amplified by reinforcement interference in a green wavelength region is represented by equation 6:

λ=4nd′ cos θ_{G} 6

However, in consideration of the tilt angle θ_{G} by unevenness, an actual optical length d′ is represented by equation 7 using a normal line d between the common electrode 270 and the translucent member 193.

d′=d cos θ_{G} 7

6 and 7 can be rearranged to equation 8.

λ=4nd cos² θ_{G} 8

Referring to equation 8, it can be seen that a wavelength of light that is amplified by reinforcement interference is proportional to the square of a tilt angle θ_{G} of unevenness.

Therefore, in the green pixel G, a microcavity condition can be set by adjusting the tilt angle θ_{G} of the unevenness in a green wavelength region.

When exposing the overcoating film 180, the tilt angle θ_{G} of unevenness can be adjusted by an exposure amount. When the exposure amount is large, the tilt angle θ_{G} of unevenness increases because an exposure depth increases in a surface of the overcoating film 180, and when the exposure amount is less, the tilt angle θ_{G} of unevenness decreases because the exposure depth decreases.

As another method, the tilt angle θ_{G} of unevenness may be adjusted by an opening size of a mask used when exposing the overcoating film 180.

Since color shifts of the red pixel R and the blue pixel B are not greater than that of the green pixel G, the red and blue pixels R and B do not have unevenness formed thereon. The color shift indicates a phenomenon in which a color looks different as a peak wavelength of a light emitting spectrum that is seen from the side surface moves toward a short wavelength or a long wavelength, compared with a peak wavelength of a light emitting spectrum that is seen from the front surface, and the color shift is very large in light of a green wavelength region among white light that is emitted from the organic emission layer 370. Since light of a red wavelength region among white light that is emitted from the organic emission layer 370 is hardly changed by a peak wavelength of a light emitting spectrum according to the change of a microcavity condition, the color shift is not large, and in light of a blue wavelength region, the color shift is not large because a phenomenon in which the spectrum moves to a short wavelength according to a viewing angle due to a cut-off phenomenon generating at a region of about 450 nm or less is limited.

Therefore, in the present exemplary embodiment, a microcavity condition in which the color shift is not generated can be set by adjusting a tilt angle θ_{G} of unevenness that is formed in a surface of an overcoating film of the green pixel G after a microcavity condition is set to simultaneously satisfy a reinforcement interference condition in the red pixel R and the blue pixel B.

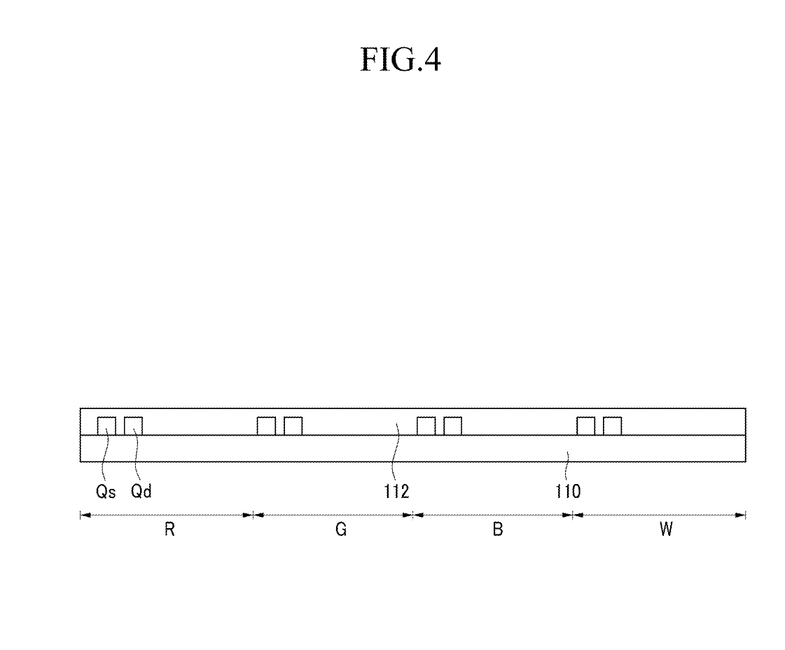

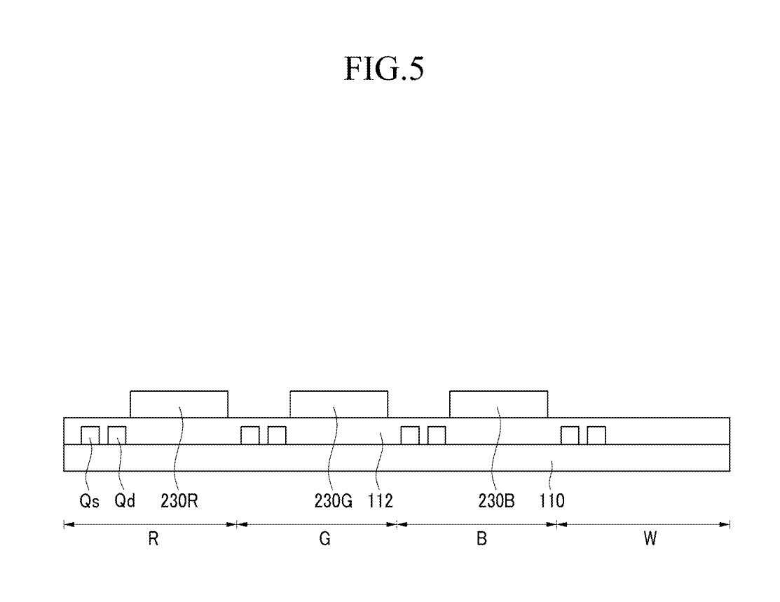

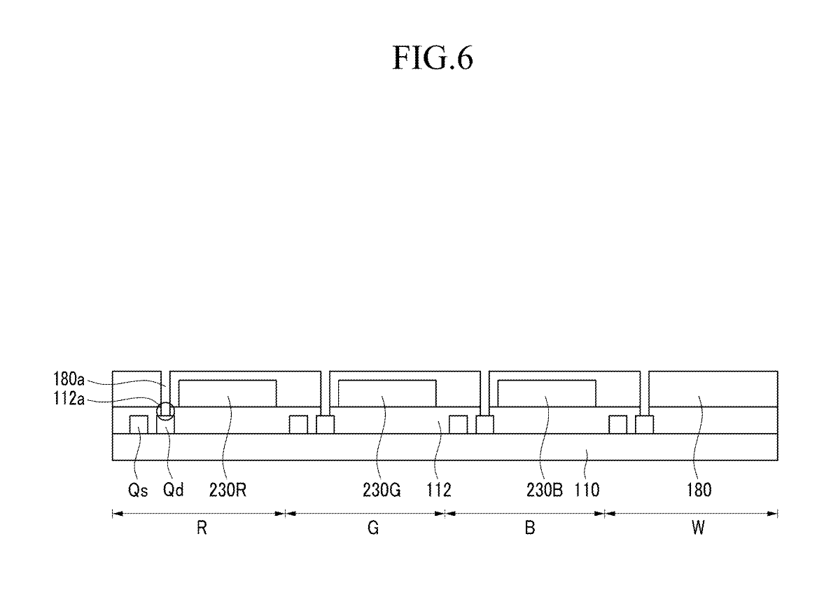

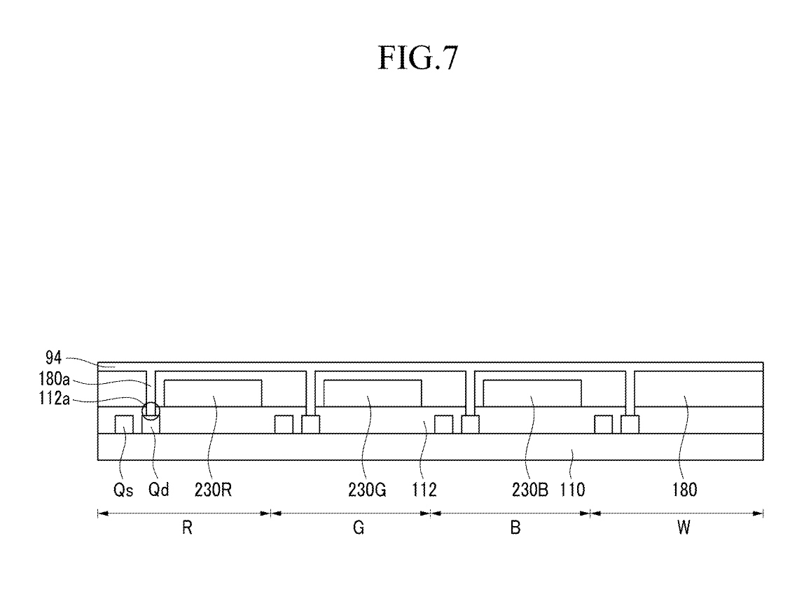

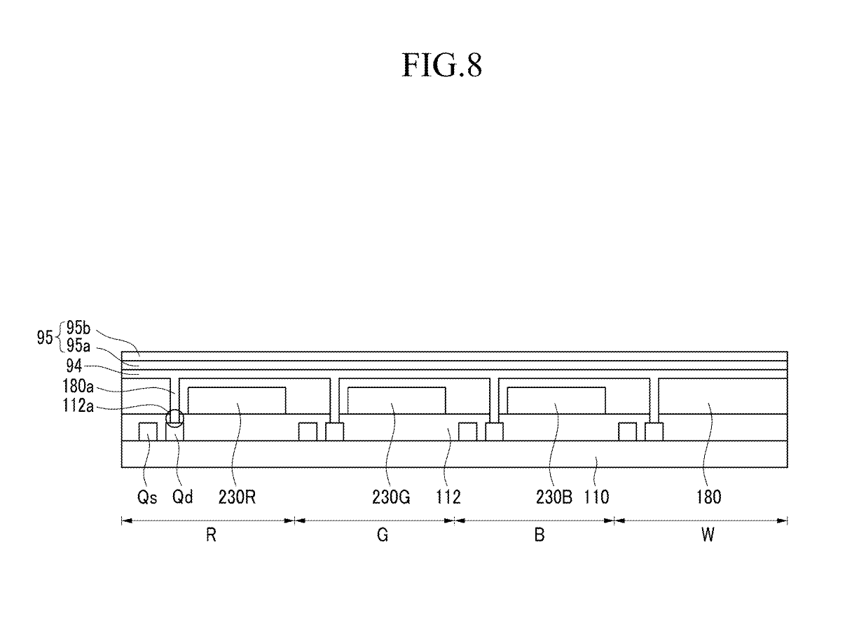

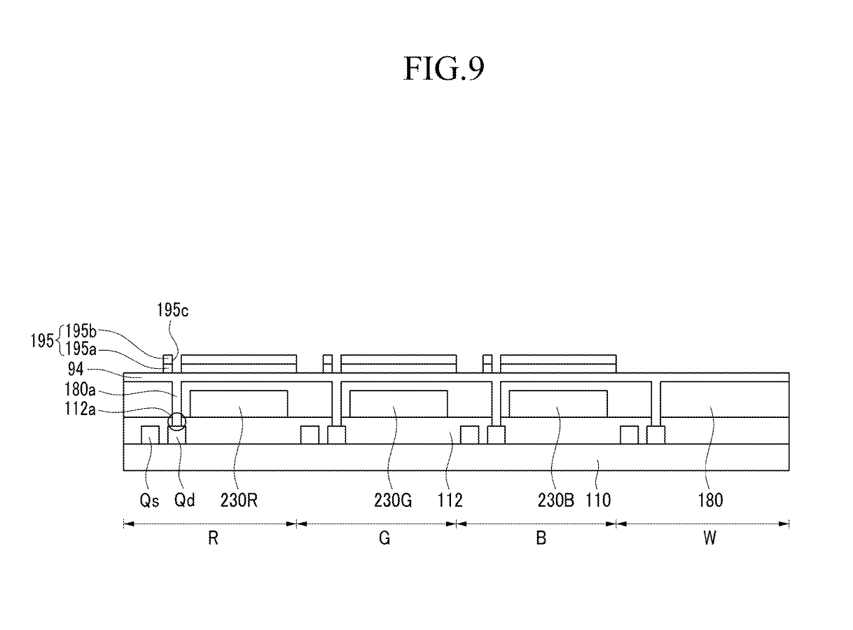

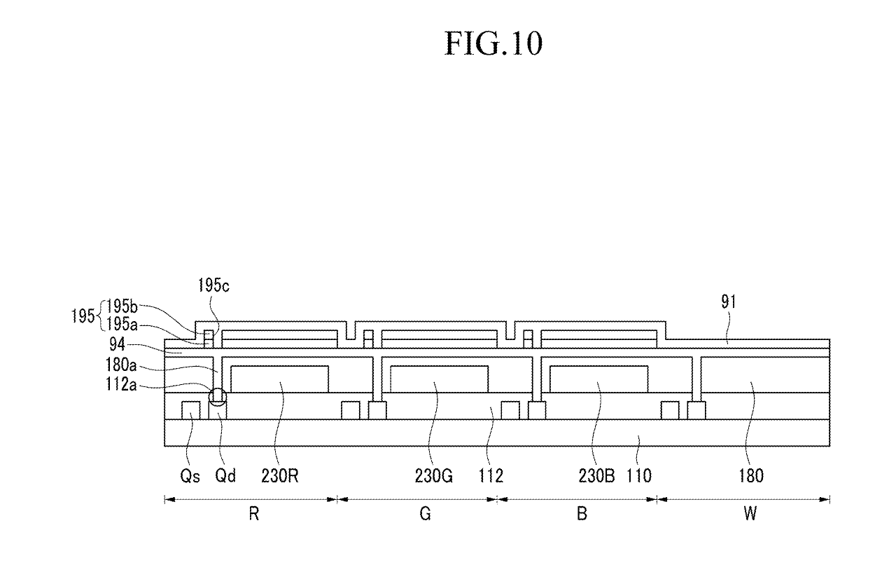

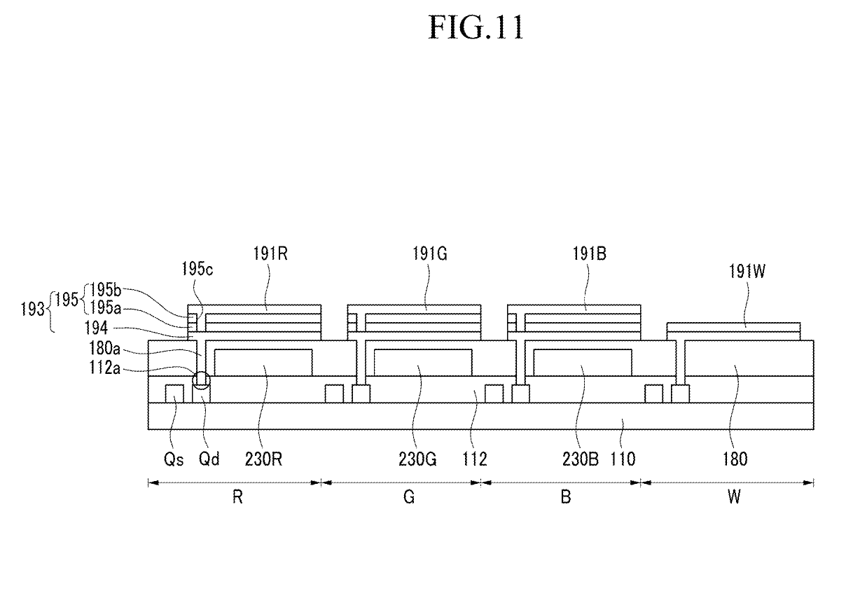

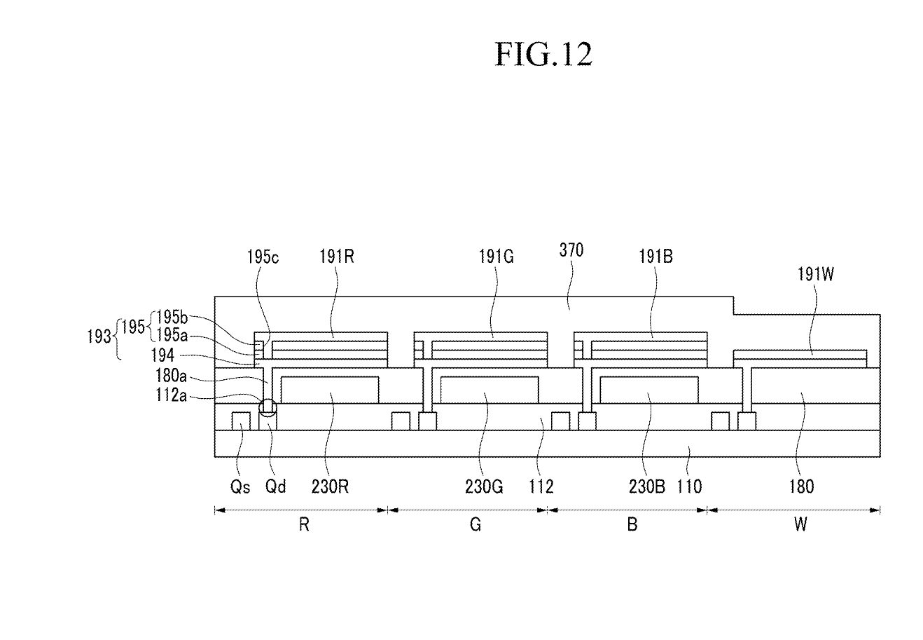

A method for manufacturing an OLED display according to the present exemplary embodiment will now be described with reference to FIG. 4, FIG. 5, FIG. 6, FIG. 7, FIG. 8, FIG. 9, FIG. 10, FIG. 11, FIG. 12 and FIG. 13

FIG. 4, FIG. 5, FIG. 6, FIG. 7, FIG. 8, FIG. 9, FIG. 10, FIG. 11, FIG. 12 and FIG. 13 are cross-sectional views illustrating a method of manufacturing the OLED of FIG. 3 according to an exemplary embodiment of the invention.

Referring to FIG. 4, switching TFTs Qs and driving TFTs Qd are formed on the insulation substrate 110. Here, the switching TFT Qs and the driving TFT Qd are formed by stacking and patterning a conductive layer (not shown), an insulating layer (not shown), and a semiconductor layer (not shown).

An insulating layer 112 is formed on the switching TFT Qs and the driving TFT Qd.

Referring to FIG. 5, color filters 230R, 230G, and 230B are formed on the insulating layer 112.

Referring to FIG. 6 and FIG. 13, an overcoating film is formed on the insulating layer 112 and the color filters 230R, 230G, and 230B. Contact holes 180a are formed in the overcoating film 180. Contact holes 112a that partially expose the driving TFT Qd are formed in the insulating layer 112. Unevenness can be formed on the surface of an overcoating film 180 of the green pixel G by arranging a mask having a translucent unit and performing a photolithography process thereon.

Referring to FIG. 7, a first transparent conductive layer 94 is formed by arranging a transparent metal on the entire surface of the overcoating film 180. Here, the first transparent conductive layer 94 may contact the driving TFT Qd through the contact holes 112a in the insulating layer 112 and the contact holes 180a in the overcoating film 180.

Referring to FIG. 8, an insulating layer 95 is formed on the first transparent conductive layer 94. The insulating layer 95 may be formed of repeating layers of a silicon oxide layer 95a and a silicon nitride layer 95b. The insulating layer 95 may be formed with a chemical vapor deposition (CVD) method.

Referring to FIG. 9, an inorganic layer 195 is formed on pixels R, G, and B, excluding a white pixel W, by etching the insulating layer 95. At this time, contact holes 195c are formed in the inorganic layer 195.

Referring to FIG. 10, a second transparent conductive layer 91 is arranged on the inorganic layer 195 and the first transparent conductive layer 94. Here, the second transparent conductive layer 91 contacts the first transparent conductive layer 94 through the plurality of contact holes 195c

Referring to FIG. 11, a metal layer 194 of the translucent member 193 and pixel electrodes 191R, 191G, 191B are formed in each pixel by performing a photolithography process with one mask on the first transparent conductive layer 94 and the second transparent conductive layer 91. According to the present embodiment, a refractive index of a material (i.e., IZO or ITO) of the lowest layer of the DBR is about 2.0 and a refractive index of silicon oxide which is a material of a layer above the lowest layer is about 1.4, and thus the refractive indexes of the two layers have a great difference. Accordingly, a light reinforcement effect can be obtained through microcavities.

Since a metal layer 194 is formed between the overcoating film 180 and an inorganic layer 195 of a translucent member 193, the translucent member 193 and the inorganic layer 195 can be etched without damage to the overcoating film 180.

Referring to FIG. 12, an emission layer 370 may be formed by sequentially stacking a red emission layer (not shown), a blue emission layer (not shown), and a green emission layer (not shown) on the entire surface of the substrate. The emission layer 370 may also be formed of a single layer that emits a white color.

Referring back to FIG. 3, a common electrode 270 is formed on the emission layer 370.

It will appear to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An organic light emitting diode (OLED) display comprising:
a substrate;
an overcoating film disposed on the substrate;
a plurality of translucent members disposed on the overcoating film, each translucent member comprising a multi-layered structure comprising a metal layer as the lowest layer;
a plurality of first electrodes disposed on the translucent members;
a plurality of emission members disposed on the first electrodes; and
a second electrode disposed on the emission members.

2. The OLED display of claim 1, wherein each translucent member further comprises an inorganic layer disposed on the metal layer.

3. The OLED display of claim 1, wherein the metal layer and the first electrode have substantially the same planar shape.

4. The OLED display of claim 3, wherein the metal layer and the first electrode comprise a transparent conductive material.

5. The OLED display of claim 4, wherein the transparent conductive material comprises IZO or ITO.

6. The OLED display of claim 2, wherein the inorganic layer comprises a first layer and a second layer having different refractive indices from each other and that are repeatedly stacked.

7. The OLED display of claim 6, wherein the first layer comprises silicon oxide, and the second layer comprises silicon nitride.

8. The OLED display of claim 1, wherein the OLED display comprises a first pixel, a second pixel, and a third pixel representing different colors, and
wherein each of the first pixel, the second pixel, and the third pixel comprises one of the translucent members, one of the emission members, one of the first electrodes, and the second electrode.

9. The OLED display of claim 8, wherein the OLED display further comprises a white pixel,
the white pixel comprises the metal layer, one of the emission members, one of the first electrodes, and the second electrode, the translucent member of each of the first pixel, the second pixel, and the third pixel further comprises an inorganic layer disposed between the metal layer and the first electrode, and
the first electrode of the white pixel is directly on the metal layer of the white pixel.

10. The OLED display of claim 8, wherein each of the first pixel, the second pixel, and the third pixel further comprises a color filter disposed under the first electrode.

11. The OLED display of claim 8, wherein a portion of the overcoating in at least one of the first pixel, the second pixel, and the third pixel has an uneven top surface.

12. A method of manufacturing an organic light emitting diode (OLED) display, the method comprising:
forming a thin film transistor (TFT) on a substrate;
forming an overcoating film on the substrate and the TFT;
forming a first transparent conductive layer on the overcoating film;
forming an inorganic layer on the first transparent conductive layer;
forming a second transparent conductive layer on the inorganic layer;
etching the second transparent conductive layer and the first transparent conductive layer to form a first electrode and a metal layer;
forming an emission member on the first electrode; and
forming a second electrode on the emission member.

13. The manufacturing method of claim 12, wherein etching the second transparent conductive layer and the first transparent conductive layer comprises:
etching the second transparent conductive layer and the first transparent conductive layer by a single photolithography process.

14. The manufacturing method of claim 12, further comprising:
forming unevenness on a surface of the overcoating film.

15. The manufacturing method of claim 14, wherein forming unevenness on the surface of the overcoating film comprises:
placing a mask having an opening on the overcoating film;
exposing the overcoating film to light through the mask; and
performing heat treatment on the overcoating film after the light exposure.
